(19) United States
(12) Patent Application Publication
(10) Pub. No.: US 2013/0059219 A1
(43) Pub. Date: Mar. 7, 2013

(54) FUEL CELL SYSTEM

(71) Applicants: Hiroko Kimura, Susono-shi (JP); Atsuo Iio, Susono-shi (JP); Naoki Takehiro, Suntou-gun (JP); Tatsuya Arai, Susono-shi (JP); Koshi Sekizawa, Susono-shi (JP)

(72) Inventors: Hiroko Kimura, Susono-shi (JP); Atsuo Iio, Susono-shi (JP); Naoki Takehiro, Suntou-gun (JP); Tatsuya Arai, Susono-shi (JP); Koshi Sekizawa, Susono-shi (JP)

(73) Assignee: TOYOTA JIDOSHA KABUSHIKI KAISHA, Toyota-shi, Aichi-ken (JP)

(21) Appl. No.: 13/133,318

(22) PCT Filed: May 25, 2010
(86) PCT No.: PCT/JP2010/058839

§ 371 Date: Jun. 22, 2011

(51) Int. Cl. H01M 8/24; H01M 8/04

(52) U.S. Cl. 429/431; 429/465

(57) ABSTRACT

A fuel cell system which prevents a reduction in catalyst activity, wherein at least one of the anode catalyst layer and the cathode catalyst layer includes a core-shell type catalyst particle having a core portion including a core metallic material and a shell portion covering the core portion and including a shell metallic material; and wherein the fuel cell system has: a means for storing an initial value of a ratio of the core metallic material to a surface area of the core-shell type catalyst particle, and a means for determining whether or not the ratio of the core metallic material to the surface area of the core-shell type catalyst particle is increased at a predetermined stage, compared to the initial value.

### TECHNICAL FIELD

The present invention relates to a fuel cell system which prevents a reduction in catalyst activity.

### BACKGROUND ART

A fuel cell converts chemical energy directly to electrical energy by supplying a fuel and an oxidant to two electrically-connected electrodes and causing electrochemical oxidation of the fuel. Unlike thermal power generation, fuel cells are not limited by Carnot cycle, so that they can show high energy conversion efficiency. In general, a fuel cell is formed by stacking a plurality of single fuel cells each of which has a membrane electrode assembly as a fundamental structure, in which an electrolyte membrane is sandwiched between a pair of electrodes. Especially, a solid polymer electrolyte fuel cell which uses a solid polymer electrolyte membrane as the electrolyte membrane is attracting attention as a portable and mobile power source because it has such advantages that it can be downsized easily, operate at low temperature, etc.

In a solid polymer electrolyte fuel cell, the reaction represented by the following formula (I) proceeds at an anode (fuel electrode) in the case of using hydrogen as fuel:

H₂→2H⁺+2e⁻ Formula (I)

Electrons generated by the reaction represented by the formula (I) pass through an external circuit, work by an external load, and then reach a cathode (oxidant electrode). Protons generated by the reaction represented by the formula (I) are, in the state of being hydrated and by electro-osmosis, transferred from the anode side to the cathode side through the solid polymer electrolyte membrane.

In the case of using oxygen as an oxidant, the reaction represented by the following formula (II) proceeds at the cathode:

2H⁺+(½)O₂+2e⁻→H₂O Formula (II):

Water produced at the cathode passes mainly through a gas diffusion layer and is discharged to the outside. Accordingly, fuel cells are clean power source that produces no emissions except water.

In the fuel cell, a long-time operation causes elution of ionic and inorganic impurities contained in a metallic material, which is a constitutional material of the fuel cell. As a technique for recovering catalyst activity from catalyst poisoning caused by the impurities eluted as described above, Patent Literature 1 discloses a fuel cell system comprising a fuel cell which comprises a membrane electrode assembly in which a catalyst layer and a gas diffusion layer of a fuel electrode are provided on one surface of an electrolyte membrane, while a catalyst layer and a gas diffusion layer of an oxidant electrode are provided on the other surface of the same, and the fuel cell generates electricity when the fuel electrode and oxidant electrode are supplied with fuel gas and oxidant gas, respectively. The fuel cell system has a means for recovering catalyst activity, which recovers catalyst activity by increasing the moisture content of the catalyst layer in the oxidant electrode of the fuel cell a predetermined value or more, and then recovering catalyst activity by an electrochemical process. The catalyst activity recovering means keeps the potential of the oxidant electrode higher than the natural potential for a predetermined period of time.

### CITATION LIST

### Patent Literature

Patent Literature 1: Japanese Patent Application Laid-Open (JP-A) No. 2007-207669

### SUMMARY OF INVENTION

### Technical Problem

The fuel cell system disclosed in Patent Literature 1 specializes only in a recovering means in the case where, as described in its Claim 4, an electrode catalyst is poisoned by sulfur. Therefore, such a fuel cell system cannot recover catalyst activity of the electrode catalyst from other poisoning.

The present invention has been made in view of the above circumstances, and it is an object of the present invention to provide a fuel cell system which prevents a reduction in catalyst activity.

### Solution to Problem

The fuel cell system of the present invention comprises a fuel cell which comprises single fuel cells, each of which comprises a membrane electrode assembly in which an anode electrode comprising an anode catalyst layer is provided on one surface of a polymer electrolyte membrane, while a cathode electrode comprising a cathode catalyst layer is provided on the other surface of the polymer electrolyte membrane, wherein at least one of the anode catalyst layer and the cathode catalyst layer comprises a core-shell type catalyst particle having a core portion comprising a core metallic material and a shell portion covering the core portion and comprising a shell metallic material: and wherein the fuel cell system has: a means for storing an initial value of a ratio of the core metallic material to a surface area of the core-shell type catalyst particle, and a means for determining whether or not the ratio of the core metallic material to the surface area of the core-shell type catalyst particle is increased at a predetermined stage, compared to the initial value.

In the present invention, it is preferable that the determining means makes a determination based on a detection result that indicates gas desorption from the core-shell type catalyst particle and/or a detection result of the gas desorbed.

In the present invention, from the point of view that deterioration of the core-shell type catalyst particle can be determined with higher accuracy by comparing an abundance ratio of the core and shell metallic materials on the surface of the core-shell type catalyst particle, the determining means can make a determination based on the ratio of the core metallic material to the surface area of the core-shell type catalyst particle, which is obtained by comparing a current peak at a potential at which first gas that is supplied to at least the membrane electrode assembly and/or an oxide of the first gas is desorbed from the core metallic material, with a current peak at a potential at which the first gas and/or oxide thereof is desorbed from the shell metallic material.

In the present invention, the first gas can be carbon monoxide.

In the present invention, the core metallic material can be a metallic material which absorbs second gas that is supplied to at least the membrane electrode assembly, and the determining means can make a determination based on the presence of a current peak at a potential at which the second gas is released from the core metallic material.

In the present invention, from the point of view that the deterioration of the core-shell type catalyst particle can be determined with higher accuracy, the determining means can further make a determination based on an integrated value of the current peak.

In the present invention, the second gas can be hydrogen gas.

In the present invention, from the point of view that the second gas can be absorbed by the core metallic material more easily and more accurate determination is thus possible by the determining means, oxidant gas can be supplied to the cathode electrode, and an amount of the oxidant gas supplied upon executing the determining means can be lower than that of oxidant gas supplied in normal operation.

In the present invention, from the point of view that the core metallic material precipitated on the surface of the core-shell type catalyst particle can be removed, a voltage higher than a standard electrode potential of the core metallic material can be applied to the fuel cell when it is determined by the determining means that the ratio of the core metallic material to the surface area of the core-shell type catalyst particle is increased compared to the initial value.

In the present invention, from the point of view that the core metallic material precipitated on the surface of the core-shell type catalyst particle can be removed without eluting the shell metallic material, the standard electrode potential of the core metallic material can be less than a standard electrode potential of the shell metallic material, and the voltage applied to the fuel cell can be within the range from the standard electrode potential of the core metallic material to less than the standard electrode potential of the shell metallic material.

In the present invention, from the point of view that the eluted core metallic material can be precipitated in a desired thickness direction position in the solid electrolyte membrane, when a voltage higher than the standard electrode potential of the core metallic material is applied to the fuel cell, a concentration of gas which is supplied to one of the anode electrode and the cathode electrode can be increased higher than that of the same which is generally supplied; or a concentration of gas which is supplied to the other electrode can be decreased lower than that of the same which is generally supplied; or the concentrations of the gasses can be controlled at the same time.

In the present invention, from the point of view that the core metallic material eluted from the cathode electrode can be precipitated in a thickness direction position that is close to the anode electrode in the solid electrolyte membrane, the core-shell type catalyst particles can be contained only in the cathode catalyst layer, and when a voltage higher than the standard electrode potential of the core metallic material is applied to the fuel cell, a concentration of oxidant gas which is supplied to the cathode electrode can be increased higher than that of the same which is generally supplied; or a concentration of fuel gas which is supplied to the anode electrode can be decreased lower than that of the same which is generally supplied; or the concentrations of the gasses can be controlled at the same time.

In the present invention, from the point of view that it is possible to determine, without specially supplying predetermined gas, whether or not the ratio of the core metallic material to the surface area of the core-shell type catalyst particle is increased compared to the initial value, the system can have a means for detecting gas produced in the cathode electrode, and the determining means can make a determination based on a detection result obtained by the detecting means.

In the present invention, the cathode catalyst layer of the cathode electrode can comprise a carbon carrier as a catalyst carrier, and the detecting means can detect carbon dioxide.

### Advantageous Effects of Invention

The present invention can detect deterioration of the core-shell type catalyst particle by comparing the ratio of the core metallic material on the surface of the core-shell type catalyst particle at an initial and/or predetermined stage with an initial value of the ratio.

### BRIEF DESCRIPTION OF DRAWINGS

FIG. 1 is a view showing an example of the fuel cell used in the present invention, and is also a view schematically showing a cross section of the same in its layer stacking direction.

FIG. 2 is a schematical view of an embodiment of the fuel cell system of the present invention, which is equipped with a CO source.

FIG. 3 is a flowchart showing an example of a routine for executing a determining means (1).

FIG. 4 is a view showing voltammograms of palladium catalyst particles after supplying hydrogen gas.

FIG. 5 is a schematical view of an embodiment of the fuel cell system of the present invention.

FIG. 6 is a flowchart showing an example of a routine for executing a determining means (2) and a means for recovering deterioration of a core-shell type catalyst particle.

FIG. 7 is a schematical view showing a distribution of gas concentrations in an electrolyte membrane in a membrane electrode assembly when controlling the gas concentrations.

FIG. 8 is a schematical view showing a distribution of gas concentrations in an electrolyte membrane in a membrane electrode assembly under normal control of the gas concentrations.

FIG. 9 is a schematical view of an embodiment of the fuel cell system of the present invention, which is equipped with a CO₂ sensor.

FIG. 10 is a flowchart showing an example of a routine for executing a determining means (3).

### DESCRIPTION OF EMBODIMENTS

The fuel cell system of the present invention comprises a fuel cell which comprises single fuel cells, each of which comprises a membrane electrode assembly in which an anode electrode comprising an anode catalyst layer is provided on one surface of a polymer electrolyte membrane, while a cathode electrode comprising a cathode catalyst layer is provided on the other surface of the polymer electrolyte membrane, wherein at least one of the anode catalyst layer and the cathode catalyst layer comprises a core-shell type catalyst particle having a core portion comprising a core metallic material and a shell portion covering the core portion and comprising a shell metallic material; and wherein the fuel cell system has: a means for storing an initial value of a ratio of the core metallic material to a surface area of the core-shell type catalyst particle, and a means for determining whether or not the ratio of the core metallic material to the surface area of the core-shell type catalyst particle is increased at a predetermined stage, compared to the initial value.

Conventionally, metals having high catalyst activity have been employed as the electrode catalyst for fuel cells, such as platinum and the like. However, despite the fact that platinum and the like are very expensive, catalysis takes place only on the surface of a platinum particle, and the inside of the particle rarely participates in catalysis. Therefore, the catalyst activity of the platinum catalyst is not necessarily high, relative its material cost.

To overcome such an issue, the inventors of the present invention have focused attention on a core-shell type catalyst comprising a core portion and a shell portion covering the core portion. In the core-shell type catalyst, the inside of the particle, which rarely participates in catalysis, can be formed at a low cost by using a relatively inexpensive material for the core portion.

The core-shell type catalyst has such a unique problem that the core metallic material comprising the core portion is dispersed and precipitated on the shell portion after a longtime use, resulting in a decrease in the catalyst activity of the core-shell type catalyst. Since the core metallic material is not eluted only by increasing the temperature of the fuel cell, recovery from such deterioration is difficult by the conventional art.

There is also a problem that once part of the shell portion is eluted to render the shell portion defective, even the core portion is also eluted to destroy the core-shell structure, resulting in a rapid decrease in the catalyst activity of the whole of the core-shell type catalyst. This problem occurs very often particularly when a standard electrode potential of the material used for the core portion is lower than that of the material used for the shell portion. It is possible to improve a problem with durability by using a core-shell type catalyst having a thick shell portion; however, such a core-shell type catalyst requires the use of a large amount of expensive noble metal such as platinum, thereby increasing the cost.

As a result of diligent efforts, the inventors of the present invention have found a method which can detect the deterioration of the core-shell type catalyst particle by comparing the ratio of the core metallic material to the surface area of the core-shell type catalyst particle with the initial value of the ratio, and can recover the deterioration based on the detected result. Thus, the inventors have achieved the present invention.

Hereinafter, the core-shell type catalyst particle used in the present invention and the fuel cell comprising the core-shell type catalyst particle will be described. Then, the fuel cell system of the present invention will be described.

### 1. Core-Shell Type Catalyst Particle Used in the Present Invention

The core-shell type catalyst particle used in the present invention has a core portion comprising a core metallic material and a shell portion covering the core portion and comprising a shell metallic material. It is preferable that the shell metallic material is selected from materials from the viewpoint of catalyst function, and the core metallic material is selected from materials mainly from the viewpoint of cost.

From the point of view that it is possible to inhibit the elution of the core portion further, a coverage of the shell portion on the core portion is preferably from 0.9 to 1. If the coverage of the shell portion on the core portion is less than 0.9, the core portion is eluted by an electrochemical reaction, so that there is a possibility that the core-shell type catalyst particle is deteriorated.

“Coverage of the shell portion on the core portion” means a ratio of the area of the core portion which is covered with the shell portion, with the premise that the total surface area of the core portion is 1. As the method for calculating the coverage, for example, there may be mentioned a method comprising the steps of observing several sites on the surface of the core-shell type catalyst particle by means of a TEM and calculating the ratio of the area of the core portion, which is confirmed by the observation to be covered with the shell portion, to the whole observed area.

Also, it is possible to calculate the coverage of the shell portion on the core portion by investigating components that are present on the outermost surface of the core-shell type catalyst particle by X-ray photoelectron spectroscopy (XPS) or time of flight secondary ion mass spectrometry (TOF-SIMS), etc.

As the core portion, there can be employed a core portion that comprises a metallic crystal having a crystal system that is a cubic system and a lattice constant of a=3.60 to 4.08 Å. Examples of materials which can form such a metallic crystal include metallic materials such as palladium, copper, nickel, rhodium, silver, gold, iridium and alloys thereof. Among them, palladium is preferably used as the core metallic material.

On the other hand, as the shell portion, there can be employed a shell portion that comprises a metallic crystal having a crystal system that is a cubic system and a lattice constant of a=3.80 to 4.08 Å. Examples of materials which can form such a metallic crystal include metallic materials such as platinum, gold, iridium and alloys thereof. Among them, platinum is preferably contained in the shell portion.

By employing both the core metallic material having the lattice constant and the shell portion containing the metallic crystal having the lattice constant, no lattice mismatch occurs between the core and shell portions; therefore, a core-shell type catalyst particle can be obtained, which has a high coverage of the shell portion on the core portion.

In the core-shell type catalyst particle used in the present invention, the shell portion covering the core portion is preferably a monatomic layer. Such a particle is advantageous in that the catalytic performance of the shell portion is extremely high and the material cost is low because the covering amount of the shell portion is small, compared with a core-shell type catalyst having a shell portion comprising two or more atomic layers.

The core-shell type catalyst particle used in the present invention preferably has an average particle diameter of 4 to 20 nm.

Because the shell portion of the core-shell type metallic nanoparticle used in the present invention is preferably a monatomic layer, the shell portion preferably has a thickness from 0.17 to 0.23 nm. Therefore, the thickness of the shell portion is negligible relative to the average particle diameter of the core-shell type metallic nanoparticle, and it is preferable that the average particle diameter of the core portion is almost equal to that of the core-shell type metallic nanoparticle.

The core-shell type catalyst particle used in the present invention can be supported by a carrier. Particularly from the viewpoint of imparting electroconductivity to an electrode catalyst layer, the carrier is preferably an electroconductive material.

Specific examples of the electroconductive material which can be used as the carrier include: electroconductive carbon materials including carbon particles such as Ketjen black (product name; manufactured by: Ketjen Black International Company), VULCAN (product name; manufactured by: Cabot Corporation), Norit (product name; manufactured by: Norit Nederland BV), BLACK PEARLS (product name; manufactured by: Cabot Corporation) and Acetylene Black (product name; manufactured by: Chevron Corporation), and carbon fibers; and metallic materials such as metallic particles and metallic fibers.

Next, a method for producing the core-shell type catalyst particle used in the present invention will be described.

The method for producing the core-shell type catalyst particle comprises at least the steps of (1) preparing a core particle and (2) covering a core portion by a shell portion. The production method is not necessarily limited to the two steps only, and in addition to the two steps, the method can comprise a filtration/washing step, a drying step, a pulverization step, etc., which will be described below.

Hereinafter, the above steps (1) and (2), and other steps will be described in order.

In the present invention, to describe a predetermined crystal plane of the metallic crystal, a combination of the chemical formula (In the case of a simple substance, chemical symbol) and predetermined crystal plane of the crystal is used, the formula showing the chemical composition of the crystal. For example, “Pd{100}plane” refers to the {100}plane of a palladium metallic crystal. In the present invention, equivalent crystal planes are each put in curly braces to describe. For example, (110)plane, (101)plane, (011)plane, (**0)plane, (*0*)plane and (0**)plane (numbers each represented by an asterisk (*) refer to “1 with an overbar”) are all represented by {110}plane.

### 1-1. Step of Preparing Core Particle

This is a step of preparing a core particle comprising the above-mentioned core metallic material.

A particle can be prepared as the core particle, on which surface a small area of {100}plane of the core metallic material are present. As the method for producing a core particle which selectively has crystal planes other than the {100}face of the core metallic material on the surface thereof, conventionally known methods can be employed.

For example, a reference (Norimatsu, et al., Shokubai, vol. 48 (2), 129 (2006)) and soon disclose a method for producing, when the core particle is a palladium particle, a palladium particle on which surface Pd{111}planes are selectively present.

As the method for measuring crystal planes on the core particle, for example, there may be mentioned a method for observing several sites on the surface of the core particle by means of a TEM, etc.

As the core particle, the metallic material listed above in the description of the core portion can be used. The core particle can be supported by a carrier. Examples of the carrier are the same as the above listed examples.

The average particle diameter of the core particle is not particularly limited as long as it is equal to or less than the average particle diameter of the above mentioned core-shell type catalyst particle.

However, when a palladium particle is used as the core particle, the larger the average particle diameter of the palladium particle, the higher the ratio of the area of the Pd{111}plane on the surface of the particle. This is because Pd{111}face is the most chemically stable crystal plane among Pd{111}plane, Pd{110}plane and Pd{100}plane. Therefore, when a palladium particle is used as the core particle, it is preferable that the palladium particle has an average particle diameter of 10 to 100 nm. From the point of view that the ratio of the surface area of one palladium particle to the cost per palladium particle is high, it is particularly preferable that the palladium particle has an average particle diameter of 10 to 20 nm.

### 1-2. Step of Covering Core Portion by Shell Portion

This is a step of covering the core particle, which is the core portion, by a shell portion.

The covering of the core portion by the shell portion can be performed through a one-step reaction or multiple-step reaction.

Hereinafter, there will be mainly described an example of the covering of the core portion by the shell portion through a two-step reaction.

As the step of covering the core portion by the shell portion through a two-step reaction, there may be mentioned an example that comprises at least the steps of covering a core particle, which is the core portion, by a monatomic layer and replacing the monatomic layer with the shell portion.

A specific example of the above is a method comprising the steps of preliminarily forming a monatomic layer on the surface of the core portion by underpotential deposition and replacing the monatomic layer with the shell portion. As the underpotential deposition, Cu-UPD is preferably used.

Particularly when a palladium particle is used as the core particle and platinum is used for the shell portion, a core-shell type catalyst particle with a high platinum coverage and excellent durability can be produced by Cu-UPD. This is because, as described above, copper can be precipitated on the Pd{111}planes and/or Pd{110}planes by Cu-UPD at a coverage of 1.

Hereinafter, a specific example of Cu-UPD will be described.

First, palladium powder supported by an electroconductive carbon material (hereinafter referred to as Pd/C) is dispersed in water and filtered to obtain a Pd/C paste, and the paste is applied onto a working electrode of an electrochemical cell. For the working electrode, a platinum mesh or glassy carbon can be used.

Next, a copper solution is added to the electrochemical cell. In the copper solution, the working electrode, a reference electrode and a counter electrode are immersed, and a monatomic layer of copper is precipitated on the surface of the palladium particle by Cu-UPD. An example of the specific precipitation condition is as follows:

Copper solution: Mixed solution of 0.05 mol/L of CuSO₄ and 0.05 mol/L of H₂SO₄ (nitrogen is subjected to bubbling)

Atmosphere: under a nitrogen atmosphere

Sweep rate: 0.2 to 0.01 mV/second

Potential: After the potential is swept from 0.8 V (vs RHE) to 0.4 V (vs RHE), it is clamped at 0.4 V (vs RHE).

Voltage clamp time: 60 to 180 minutes

After the above voltage clamp time is passed, the working electrode is promptly immersed in a platinum solution to replace copper with platinum by displacement plating, utilizing the difference in ionization tendency. The displacement plating is preferably performed under an inert gas atmosphere such as a nitrogen atmosphere. The platinum solution is not particularly limited. For example, a platinum solution obtained by dissolving K₂PtCl₄ in 0.1 mol/L of HClO₄ can be used. The platinum solution is sufficiently agitated to bubble nitrogen therein. The length of the displacement plating time is preferably 90 minutes or more.

A core-shell type catalyst particle is obtained by the displacement plating, in which a monatomic layer of platinum is precipitated on the surface of the palladium particle.

As the material comprising the shell portion, the metallic materials listed above in the description of the shell portion can be used.

### 1-3. Other Steps

Before the step of preparing the core particle, the core particle can be supported by a carrier. As the method for supporting the core particle by a carrier, conventionally used methods can be employed.

After the step of covering the core portion by the shell portion, there may be performed filtration/washing, drying and pulverization of the core-shell type catalyst particle.

The filtration/washing of the core-shell type catalyst particle is not particularly limited as long as it is a method that can remove impurities without damage to the core-shell structure of the particle produced. An example of the filtration/washing is performing suction and filtration after adding ultra pure water. The operation of adding ultra pure water and then performing suction and filtration is preferably repeated about 10 times.

The drying of the core-shell type catalyst particle is not particularly limited as long as it is a method that can remove a solvent, etc. An example of the drying is drying for about 12 hours with a vacuum drier in the condition of a temperature of about 60° C.

The pulverizing of the core-shell type catalyst particle is not particularly limited as long as it is a method that can pulverize solid contents. Examples of the pulverization include pulverization using a mortar, etc., and mechanical milling using a ball mill, a bead mill, a turbo mill, mechanofusion, a disk mill, etc.

### 2. Fuel Cell Comprising Core-Shell Type Catalyst Particle

In the fuel cell used in the present invention, at least one of the anode catalyst layer and the cathode catalyst layer comprises the above-mentioned core-shell type catalyst particle.

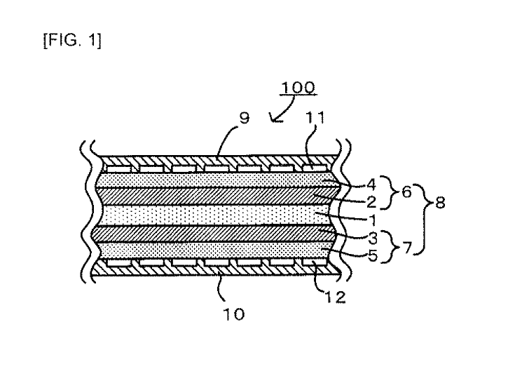

FIG. 1 is a view showing an example of the fuel cell used in the present invention, and is also a view schematically showing a cross-section of the same in its layer stacking direction. A fuel cell 100 comprises a membrane electrode assembly 8 which comprises a hydrogen ion-conductive solid polymer electrolyte membrane (hereinafter may be simply referred to as an electrolyte membrane) 1 and a pair of a cathode electrode 6 and an anode electrode 7 between which the electrolyte membrane 1 is sandwiched; moreover, the fuel cell 100 comprises a pair of separators 9 and 10 between which the membrane electrode assembly 8 is sandwiched so that the electrodes are sandwiched from the outside. Gas channels 11 and 12 are each provided at the boundary of the separator and electrode. In general, as the electrode, one which comprises a catalyst layer and a gas diffusion layer stacked in this order from closest to the electrolyte membrane, is used. That is, the cathode electrode 6 comprises a stack of a cathode catalyst layer 2 and a gas diffusion layer 4, while the anode electrode 7 comprises a stack of an anode catalyst layer 3 and a gas diffusion layer 5.

The polymer electrolyte membrane is a polymer electrolyte membrane which is used in fuel cells, and there may be mentioned fluorinated polymer electrolyte membranes which comprise a fluorinated polymer electrolyte such as a perfluorocarbon sulfonic acid resin, as typified by Nafion (product name); moreover, for example, there may be mentioned hydrocarbon polymer electrolyte membranes which comprise a hydrocarbon polymer electrolyte in which a protonic acid group (proton conducting group) such as a sulfonic acid group, a carboxylic acid group, a phosphoric acid group or a boronic acid group is introduced into a hydrocarbon polymer such as an engineering plastic (e.g., polyether ether ketone, polyether ketone, polyethersulfone, polyphenylene sulfide, polyphenylene ether, polyparaphenylene) or a commodity plastic (e.g., polyethylene, polypropylene, polystyrene).

The electrode comprises the catalyst layer and the gas diffusion layer.

Both the anode catalyst layer and cathode catalyst layer can be formed by using a catalyst ink which comprises the above-mentioned core-shell type catalyst particles, an electroconductive material and a polymer electrolyte.

As the polymer electrolyte, materials that are the same as the above-mentioned materials for the polymer electrolyte membrane can be used.

As the electroconductive particle which is a catalyst carrier, electroconductive carbon materials including carbon particles such as carbon black and carbon fibers, and metallic materials such as metallic particles and metallic fibers can be used. The electroconductive material also functions as an electroconductive material which imparts electroconductivity to the catalyst layer.

A method for forming the catalyst layer is not particularly limited. For example, the catalyst layer can be formed on the surface of a gas diffusion layer sheet by applying the catalyst ink to the surface of the gas diffusion layer sheet and drying the same, or the catalyst layer can be formed on the surface of the electrolyte membrane by applying the catalyst ink to the surface of the electrolyte membrane and drying the same. Alternatively, the catalyst layer can be formed on the surface of the electrolyte membrane or of the gas diffusion layer sheet in such a manner that the catalyst ink is applied to the surface of a transfer substrate and dried to produce a transfer sheet; the transfer sheet is attached to the electrolyte membrane or the gas diffusion sheet by hot pressing or the like; thereafter, a substrate film is removed from the transfer sheet.

The catalyst ink can be obtained by dissolving or dispersing a catalyst and an electrolyte for electrodes as mentioned above in a solvent. The solvent of the catalyst ink can be appropriately selected, and the examples include alcohols such as methanol, ethanol and propanol, organic solvents such as N-methyl-2-pyrolidone (NMP) and dimethyl sulfoxide (DMSO), mixtures of the organic solvents, and mixtures of the organic solvents and water. The catalyst ink can contain other components as needed, such as a binder and a water-repellent resin, besides the catalyst and the electrolyte.

A method for applying the catalyst ink, a method for drying the same, etc., can be appropriately selected. As the method for applying the catalyst ink, for example, there may be mentioned a spraying method, a screen printing method, a doctor blade method, a gravure printing method and a die-coating method. As the method for drying the same, for example, there may be mentioned drying under reduced pressure, heat drying and heat drying under reduced pressure. There is no limitation to the specific conditions for the drying under reduced pressure and the heat drying, so that they can be determined appropriately. The thickness of the catalyst layer is not particularly limited and can be about 1 to 50 μm.

As the gas diffusion layer sheet which forms the gas diffusion layer, there may be mentioned those having gas diffusivity which makes it possible to efficiently supply fuel to the catalyst layer, electroconductivity, and strength which is required for the material comprising the gas diffusion layer to have. The examples include those comprising electroconductive porous bodies including carbonaceous porous bodies such as carbon paper, carbon cloth and carbon felt, and metallic mesh or metallic porous bodies comprising metals such as titanium, aluminum, copper, nickel, nickel chrome alloys, copper, copper alloys, silver, aluminum alloys, zinc alloys, lead alloys, titanium, niobium, tantalum, iron, stainless steel, gold and platinum. The electroconductive porous body preferably has a thickness of about 50 to 500 μm.

The gas diffusion layer sheet can be formed of a single layer comprising the above-mentioned electroconductive porous body. Alternatively, the sheet can be such that a water-repellent layer is provided on a surface thereof which faces the catalyst layer. In general, the water-repellent layer has a porous structure which comprises, for example, electroconductive particles such as carbon particles or carbon fibers, and a water-repellent resin such as polytetrafluoroethylene (PTFE). The water-repellent layer is not always necessary; however, the water-repellent layer can increase the drainage properties of the gas diffusion layer while it can maintain the water content in the catalyst layer and the electrolyte membrane at an appropriate level; moreover, it is advantageous in improving the electrical contact between the catalyst layer and the gas diffusion layer.

The electrolyte membrane and the gas diffusion layer sheet at least one of which has the catalyst layer formed by the above method, are appropriately stacked and attached to each other by hot-pressing or the like, thereby obtaining a membrane electrode assembly.

The thus-produced membrane electrode assembly is further sandwiched between separators each of which preferably has a reaction gas channel, thereby forming a single fuel cell. As the separators, those that have electroconductive and gas sealing properties and can function as a collector and gas sealer can be used, such as carbon separators made of carbon/resin composites which contain a high concentration of carbon fibers, and metallic separators comprising metallic materials. Examples of the metallic separators include separators made of metallic materials having excellent corrosion-resistance and separators of which surface is coated with carbon or a metallic material having excellent corrosion resistance to increase the corrosion resistance. By performing compression molding or cutting work appropriately on such separators, the above-mentioned reaction gas channels can be formed.

### 3. Fuel Cell System of the Present Invention

The fuel cell system of the present invention comprises the above-mentioned fuel cell; moreover, it comprises a means for storing the initial state of the surface of the core-shell type catalyst particle contained in the fuel cell, and a means for determining the deterioration condition of the core-shell type catalyst particle.

The storing means of the fuel cell system of the present invention is a means for storing the initial value of the ratio of the core metallic material to the surface area of the core-shell type catalyst particle.

The value of “the ratio of the core metallic material to the surface area of the core-shell type catalyst particle” is a value that relates to the above-mentioned coverage of the shell portion on the core portion. That is, generally in the core-shell type catalyst particle in which said coverage is high, the ratio of the core metallic material to the surface area of the core-shell type catalyst particle is low.

The ratio of the core metallic material to the surface area of the core-shell type catalyst particle is decreased lower than the initial value when the shell portion is eluted to expose the core portion, or when a free core metallic material is attached to the shell portion surface.

“Initial value of the ratio” does not necessarily mean a value that relates to an unused core-shell type catalyst particle. That is, the initial value used herein means a value that relates to the core-shell type catalyst particle which shows performance that is higher than predetermined criteria.

Any value relating to the core-shell type catalyst particle at any stage can be the initial value. Examples of the initial value include: a value relating to the unused core-shell type catalyst particle; a value relating to the core-shell type catalyst particle upon activation of the fuel system; and a value relating to the core-shell type catalyst particle upon previous termination of the system in the case where the fuel cell system is intermittently used.

The initial value can be preset in the storing means. One or more initial values can be preset. Alternatively, one or more maps with one or more initial values can be stored in the storing means, so that an optimum map can be selected from the storing means depending on the operation environment of the fuel cell.

The initial value can be a value which is obtained from a measurement result measured by a device in or out of the fuel cell system. In this case, it is preferable that the storing means and the measuring device are electrically connected.

The storing means can be a means that reads a physical value newly as the initial value, the physical value being fed back from the below-described determining means and showing the deterioration condition of the core-shell type catalyst particle at a predetermined stage. By successively updating the initial value as described above, it is possible to obtain the data of deterioration condition of the core-shell type catalyst particle over time.

Specific examples of the means for storing the initial value include a semiconductor memory device such as memory, a magnetic-storage device such as a hard disc, etc., each of which stores the predesigned initial value.

The determining means of the fuel cell system of the present invention is a means for determining whether or not the ratio of the core metallic material to the surface area of the core-shell type catalyst particle is increased at a predetermined stage, compared to the initial value.

It is preferable that the determining means is electrically connected to the storing means to work with the same.

The determining means preferably makes a determination based on a detection result that indicates gas desorption from the core-shell type catalyst particle and/or a detection result of the gas desorbed.

Herein, detection of gas desorption does not mean detection of gas itself. It means detection of gas desorption by comparing physical properties of the core-shell type catalyst particle before and after the gas desorption, or by observing electrochemical changes of the surface of the core-shell type catalyst particle before and after the gas desorption.

Detection of gas itself does not necessarily mean the detection of only the gas released out of the fuel cell. It means the detection of the gas leaked from the electrode catalyst layer to other units in the fuel cell, the layer comprising the core-shell type catalyst particle, or the detection of the gas produced in the electrode catalyst layer.

There are three examples of the determining means utilizing the gas desorption from the core-shell type catalyst particle:

a means that makes a determination based on a comparison between a current peak at a potential at which predetermined gas is desorbed from the core metallic material and a current peak at a potential at which the predetermined gas is desorbed from the shell metallic material (determining means (1));

a means that makes a determination based on a current peak at a potential at which predetermined gas is released from the core metallic material (determining means (2)); and

a means that has a means for detecting gas produced in the cathode electrode and makes a determination based on a detection result obtained by the detecting means (determining means (3)).

Among the above three means, the determining means (1) and (2) are means that detect gas desorption from the core-shell type catalyst particle and makes a determination based on the detection result. On the other hand, the determining means (3) is a means that detects the gas itself, which is desorbed from the core-shell type catalyst particle, and makes a determination based on the detection result.

Hereinafter, the above-mentioned three determining means will be described in order.

### 3-1. Determining Means (1)

The determining means (1) is a means that makes a determination based on the ratio of the core metallic material to the surface area of the core-shell type catalyst particle, which is obtained by comparing a current peak at a potential at which predetermined gas (hereinafter, referred to as first gas) that is supplied to at least the membrane electrode assembly and/or an oxide of the first gas is desorbed from the core metallic material, with a current peak at a potential at which the first gas and/or oxide thereof is desorbed from the shell metallic material.

Measurement of the two types of current peaks and calculation of the ratio of the core metallic material can be conducted by a device which executes the determining means (1) or other device in the fuel cell system.

By the determining means (1), it is possible to compare the ratio of the core metallic material on the surface of the core-shell type catalyst particle with the ratio of the shell metallic material on the same, and to determine the deterioration of the core-shell type catalyst particle with high accuracy.

The first gas used in the determining means (1) is not particularly limited as long as it is gas which is different in the potential at which the first gas and/or oxide thereof (hereinafter, referred to as the first gas and/or the like) is desorbed from the core metallic material and the potential at which the first gas and/or the like is desorbed from the shell metallic material. Depending on the combination of the core metallic material and the shell metallic material, optimum gas can be selected and used as the first gas.

An example of the first gas used in the determining means (1) is carbon monoxide. Hereinafter, an example of the case of using carbon monoxide will be described.

An example of the determining means using carbon monoxide is CO stripping cyclic voltammetry (hereinafter, referred as to CO stripping CV). A specific example of CO stripping CV is such that carbon monoxide is adsorbed to the core-shell type catalyst particle at a low potential, and the potential is swept to a high potential side to find the potential at which carbon dioxide, which is the oxide of carbon monoxide, is desorbed from the surface of the core-shell type catalyst particle.

According to a reference (ECS Transactions, 25(1); 1011-1022; (2009)), it is shown by CO stripping CV measurement that a carbon monoxide desorption peak from the core portion of palladium alloy appears at 0.82 V (vs RHE), and a carbon monoxide desorption peak from the shell portion of platinum appears at 0.62 V (vs RHE).

By using such a principle, it is possible to estimate the amount of the core metallic material present on the surface of the core-shell type catalyst particle, from an oxidation current peak at which carbon dioxide is produced.

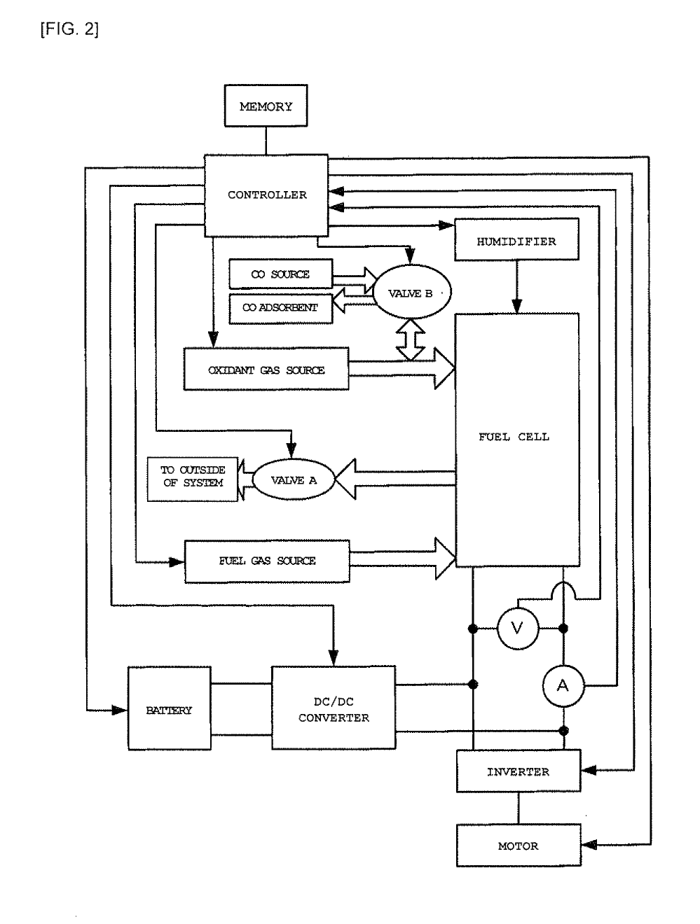

Hereinafter, a specific constitution of the fuel cell system will be described, which is in the case where a source of carbon monoxide (hereinafter, referred as to a CO source) is mounted on the system as a means for supplying carbon monoxide. FIG. 2 is a schematical view of an embodiment of the fuel cell system of the present invention, which is equipped with a CO source. In FIG. 2, solid arrows represent electrical circuits, and white arrows represent gas distribution channels. Also, the direction of the white arrows represents the approximate direction of gas distribution.

As shown in FIG. 2, the embodiment includes electric power supply mechanisms such as a battery and power mechanisms such as a motor, in addition to the above-mentioned fuel cell and auxiliaries required for the operation of the fuel cell, such as an oxidant gas source, a fuel gas source and a humidifier. As needed, the electric power supply mechanisms such as the battery and the power mechanisms such as the motor can be equipped with a power conversion device such as a DC/DC converter or inverter.

When hydrogen gas is used as fuel gas, a hydrogen gas cylinder can be used as a hydrogen gas source.

When oxygen gas is used as oxidant gas, an oxygen gas cylinder can be used as an oxygen gas source. When air is used as oxidant gas, an air compressor can be used to supply air.

The cathode catalyst layer of the fuel cell comprises the above-mentioned core-shell type catalyst particle. The fuel cell is further equipped with electrical meters such as an ammeter and a voltmeter.

A gas discharge channel (mainly for an oxidant gas discharge channel) is connected to the outside of the system through a valve A. The valve A functions to isolate the gas discharge channel of the fuel cell from the outside of the fuel cell system. By closing the oxidant gas source and the valve A, it is possible to isolate a stack and introduce carbon monoxide from the CO source only to the stack.

In the middle of an oxidant gas supply channel from the oxidant gas source to the fuel cell, a gas distribution channel branch is provided. The branch is connected to the CO source and a CO adsorbent through a valve B. The valve B functions to switch back and forth between the supply of carbon monoxide from the CO source to a predetermined stack and the adsorption of excessive carbon monoxide to the CO adsorbent from the predetermined stack.

As the CO source, a carbon monoxide cylinder can be exemplified. As the CO adsorbent, materials which have been used for carbon monoxide adsorption can be used.

Moreover, the embodiment of the present invention includes a controller. The controller controls the oxidant gas source, fuel gas source, battery, DC/DC converter, motor, inverter, humidifier and several kinds of valves.

The controller is connected to a memory storing the initial value of the ratio of the core metallic material to the surface area of the core-shell type catalyst particle and, as needed, it retrieves the initial value from the memory. Furthermore, the controller gets feedback from the ammeter and voltmeter about the information on discharge of the fuel cell.

The controller can be equipped with an electrochemical measuring device such as a potentiostat or galvanostat.

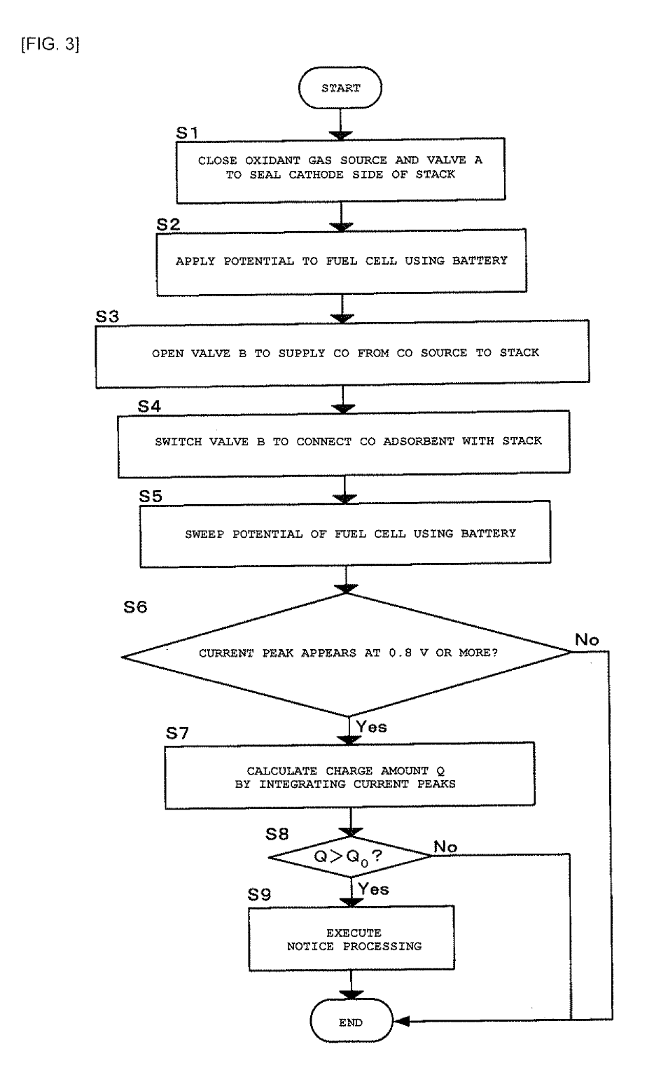

FIG. 3 is a flowchart showing an example of a routine for executing the determining means (1). Machinery names and so on in FIG. 3 correspond to those in FIG. 2. To the fuel cell, air is supplied as oxidant gas, and hydrogen is supplied as fuel gas. Also, the core portion of the core-shell type catalyst particle contains palladium, and the shell portion thereof contains platinum.

First, the oxidant gas source and the valve A are closed to seal the cathode side of the stack (S1). After a sufficient amount of time is passed in the state of closing the valve A, hydrogen supplied to the anode side penetrates into the cathode side, so that the whole stack is filled with hydrogen, water and nitrogen, and the temperature inside the stack becomes a room temperature.

Next, potential is applied to the whole fuel cell, using the battery (S2). This is to remove the oxide on the surface of the core-shell type catalyst particle and to pretreat the surface. In this case, the potential is preferably about 0.05 Viper cell. As needed, a DC-DC converter can be provided between the battery and the fuel cell for power conversion.

Then, the valve B is opened to supply carbon monoxide from the CO source to the stack (S3). By supplying carbon monoxide, the carbon monoxide supplied is absorbed to the core-shell type catalyst particles in the cathode catalyst layer.

After a predetermined period of time is passed, the valve B is switched to connect the CO adsorbent with the stack (S4). By operating a compressor (not shown), excessive carbon monoxide remaining in the stack is adsorbed to the CO adsorbent.

Thereafter, the potential of the fuel cell is swept using the battery (S5). A potential from 0.05 V to 1.0 V (vs RHE) is applied to each cell, while increasing the potential at a constant rate.

At this stage, the current value of the fuel cell is measured to determine whether or not a current peak appears at 0.8 V (vs RHE) or more (S6).

The peak at 0.8 V or more is derived from carbon dioxide (an oxide of carbon monoxide) desorbed from the core metallic material, palladium. Therefore, the peak at 0.8 V or more shows that the core metallic material appears on the surface of the core-shell type catalyst particle. When a current peak appears at 0.8 V (vs RHE) or more, a charge amount Q is calculated by integrating the current peak to estimate the ratio of the core metallic material appearing on the surface of the core-shell type catalyst particle (S7). The charge amount Q is compared to a preset value Q₀ (S8) and if Q exceeds Q₀, notice processing is executed (S9). When no current peaks appear at 0.8 V (vs RHE) or more, or when the charge amount Q is equal to or less than Q₀, the determining means (1) is terminated and normal system start-up processing is executed.

When one current peak appears at each of around 0.8 V (vs RHE) and around 0.6 V (vs RHE), it is possible to compare the amount of the platinum on the surface of the core-shell type catalyst particle with that of the palladium on the same. That is, the current peak appears at around 0.8 V (vs RHE) is derived from the carbon dioxide desorbed from the core metallic material, palladium, and the current peak which appears at around 0.6 V (vs RHE) is derived from the carbon dioxide desorbed from the shell metallic material, platinum. Therefore, the ratio of the palladium to the surface area of the core-shell type catalyst particle can be estimated by calculating the charge amount by integrating each peak.

As described above, the determining means (1) detects the deterioration of the core-shell type catalyst particle as an increase in oxidation current of the gas desorbed from the core portion, and makes a determination based on the detection result. Therefore, by executing the notice processing through the determining means (1), it is possible to take measures such as informing the fuel cell system user of the end of the lifetime of the system, encouraging the users to repair the fuel cell system, and recommending the users changing the operation mode of the fuel cell.

Moreover, by comparing the oxidation current of the gas desorbed from the core portion with that of the gas desorbed from the shell portion, the ratio of the core metallic material to the surface area of the core-shell type catalyst particle can be quantitatively calculated.

### 3-2. Determining Means (2)

The determining means (2) is a means that can be executed in the case where the core metallic material is a metallic material which absorbs predetermined gas (hereinafter, referred as to second gas) that is supplied to at least the membrane electrode assembly, and is also a means that makes a determination based on the presence of a current peak at a potential at which the second gas is released from the core metallic material.

The criteria of the determining means (2) can be simply the presence of the current peak or the integrated value of the current peak. It is possible to determine the deterioration of the core-shell type catalyst particle with higher accuracy by making a determination based on the integrated value of the current peak.

The second gas is not particularly limited as long as it is gas which makes it possible to measure the current peak at the potential at which the gas is released from the core metallic material. Depending on the type of the core metallic material, optimal gas can be selected and used as the second gas.

An example of the second gas used in the determining means (2) is hydrogen gas. Hereinafter, there will be described the case of supplying hydrogen gas to the core-shell type catalyst particle which contains palladium in the core portion and platinum in the shell portion.

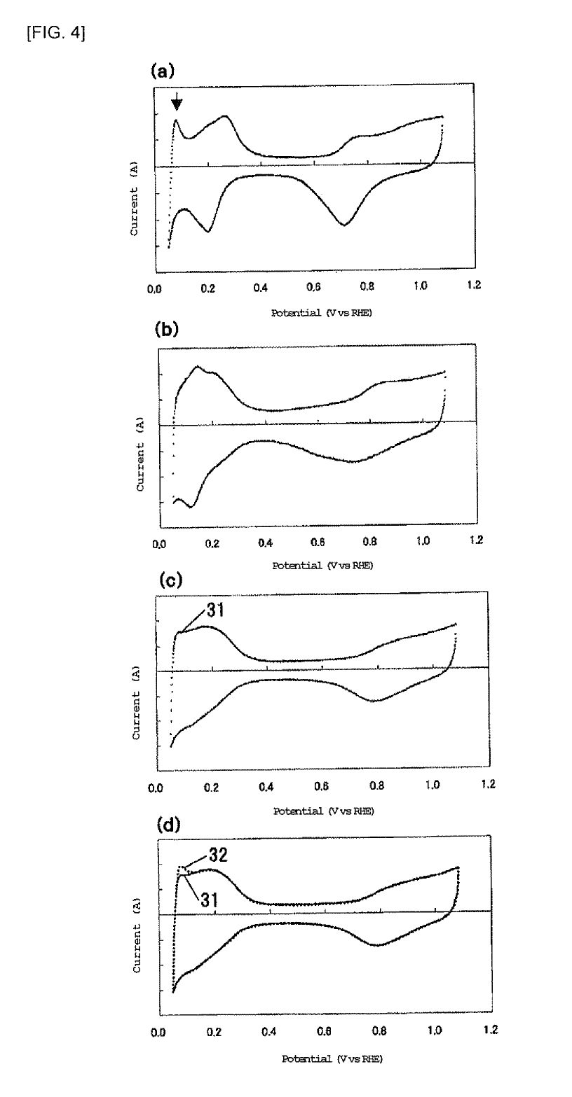

FIGS. 4(a) and 4(b) show a voltammogram of a palladium catalyst particle after supplied with hydrogen gas and a voltammogram of a platinum catalyst particle after supplied with hydrogen gas, respectively. FIG. 4(c) shows an initial voltammogram 31 of the core-shell type catalyst particle after supplied with hydrogen gas, the particle containing palladium in the core portion and platinum in the shell portion. FIG. 4 (d) is a view showing the voltammogram 31 (solid line) of the core-shell type catalyst particle, which is superimposed on a voltammogram 32 (dashed line) of the same, in the case where the core material, palladium, is estimated to be precipitated on the surface of the shell portion.

In the voltammogram of FIG. 4(a), as shown by the arrow, a current peak is clearly confirmed at around 0.05 V (vs RHE). This is a peak that is derived from the current which flows when hydrogen gas adsorbed to the palladium turns into a proton. Hereinafter, this peak is referred as to a hydrogen absorption peak.

On the other hand, in the voltammograms of FIGS. 4(b) and 4(c) and in the voltammogram 31 of FIG. 4(d), no hydrogen absorption peak appears clearly at around 0.05 V (vs RHE).

Therefore, it is expected that when the palladium of the core material is precipitated on the surface of the shell portion after long-time use of the core-shell type catalyst particle, as shown by the voltammogram 32 represented by a dashed line in FIG. 4(d), a current peak clearly appears at around 0.05 V (vs RHE).

When a hydrogen absorption peak of the palladium appears, which does not appear in the initial voltammogram of the core-shell type catalyst particle stored in the memory, it is estimated from the above-described principle that the palladium is precipitated on the surface of the core-shell type catalyst particle to cause catalyst deterioration, or a defect appears in the shell portion of the core-shell type catalyst particle to expose the core portion. Or, when the hydrogen absorption peak of the palladium is higher than the initial hydrogen absorption peak of the same stored in the memory, it is estimated that the area of the palladium precipitated on the surface of the core-shell type catalyst particle is increased to cause more serious catalyst deterioration.

By utilizing such a principle, it is possible to determine the occurrence of a deterioration in the core-shell type catalyst particle, from the current peak which shows the second gas desorption.

As the method for obtaining the voltammogram as shown in FIG. 4, there may be a method for measuring a polarogram of the core-shell type catalyst particle in a specific single cell of the fuel cell by potentiostat. In particular, the potential is swept from, for example, 0.05 V, 1.085 V and then to 0.05 V to measure the current which flows at this time.

When the determining means (2) is executed, the supply of oxidant gas to the cathode electrode can be cut off, while inert gas such as nitrogen gas is supplied instead, and the output potential of the fuel cell can be lowered. Thereby, the fuel cell stack is put in a state in which nitrogen is circulated in the cathode side of the stack, while hydrogen is circulated in the anode side of the same.

Oxidant gas comprises oxygen and air. The oxidant gas source comprises an oxygen cylinder and an air compressor.

Based on the result obtained by the determining means, the deterioration of the core-shell type catalyst particle can be recovered.

As an example of recovering of the deterioration of the core-shell type catalyst particle is to elute and remove the core metallic material on the surface of the core-shell type catalyst particle by controlling voltage. In particular, a voltage higher than the standard electrode potential of the core metallic material can be applied to the fuel cell when it is determined by the determining means that the ratio of the core metallic material to the surface area of the core-shell type catalyst particle is increased compared to the initial value.

The voltage naturally increases by opening the circuit of the fuel cell. It is also possible to control the voltage by the electric power supply mechanism equipped with the fuel cell, such as a battery, and the power conversion device as needed, such as a DC/DC converter.

In this case, it is preferable that the standard electrode potential of the core metallic material is less than the standard electrode potential of the shell metallic material, and the voltage applied to the fuel cell is within the range from the standard electrode potential of the core metallic material to less than the standard electrode potential of the shell metallic material. By setting the voltage applied to the fuel cell in this manner, the core metallic material precipitated on the surface of the core-shell type catalyst particle can be removed without eluting the shell metallic material. For example, when palladium is used for the core metallic material and platinum is used for the shell metallic material, the voltage can be controlled within the range of 0.915 V or more and less than 1.188 V.

The voltage temporarily increased to elute the core metallic material is preferably kept for a predetermined period of time. By keeping the voltage for a predetermined period of time, it is possible to completely elute the core metallic material precipitated on the surface of the core-shell catalyst; moreover, it is possible to diffuse/precipitate the core metallic material eluted into the electrode catalyst layer in the electrolyte membrane and to prevent the core metallic material from reprecipitation on the surface of the core-shell catalyst. The inside of the electrolyte membrane is under a highly acidic atmosphere since a proton conducting group such as a sulfonic acid group is generally present therein. Therefore, the core metallic material cannot be present in the form of ion and thus precipitates in the electrolyte membrane. The fuel cell can be humidified with a humidifier so that the core metallic material is likely to be diffused and move in the electrolyte membrane.

“A predetermined period of time” refers to minimum several seconds to several tens of seconds and maximum several minutes.

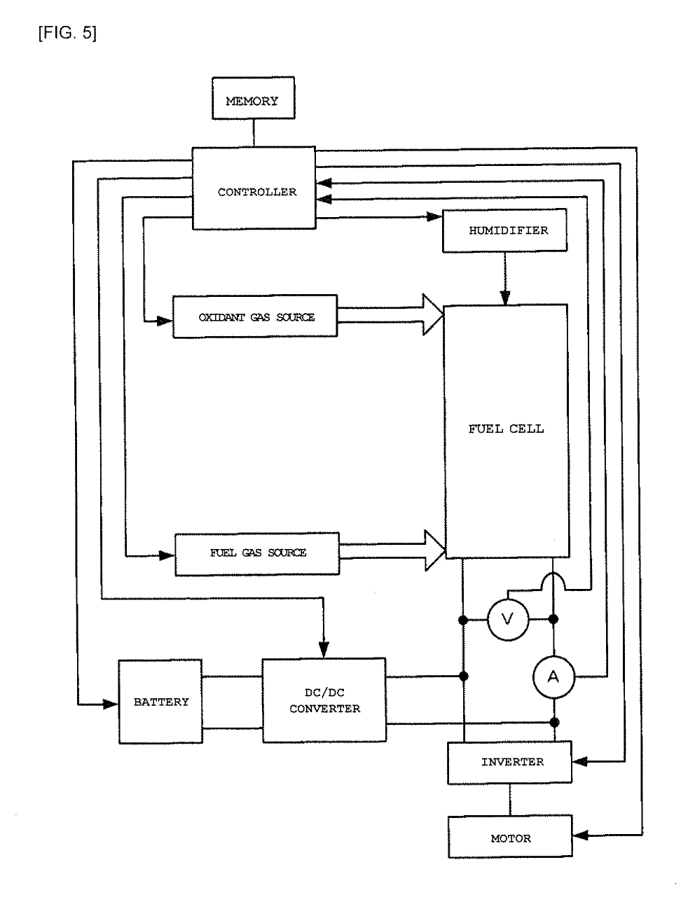

Hereinafter, a specific constitution of the fuel cell system will be described, which is in the case where the principle of hydrogen gas absorption into the core metallic material is used to make a determination. FIG. 5 is a schematical view of an embodiment of the fuel cell system of the present invention. The constitution shown in FIG. 5 is the same as the constitution shown in FIG. 2, except that a CO source, CO adsorbent, valve A and valve B are not mounted.

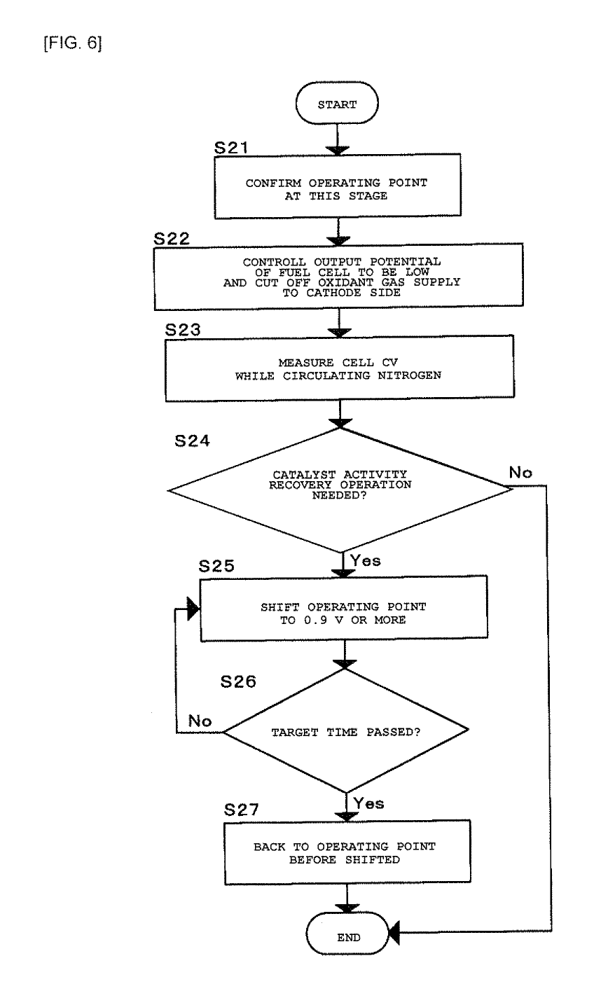

FIG. 6 is a flowchart showing an example of a routine for executing the determining means (2) and the means for recovering the deterioration of the core-shell type catalyst particle. Machinery names and so on in FIG. 6 correspond to those in FIG. 5. To the fuel cell, air is supplied as oxidant gas, and hydrogen is supplied as fuel gas. Also, the core portion of the core-shell type catalyst particle contains palladium, and the shell portion contains platinum.

First, the operating point of a part or all of the stacks in the fuel cell at this stage is confirmed (S21). Information obtained from the ammeter and voltmeter is used for the confirmation of the operating point.

Next, the output potential of the fuel cell is controlled to be low, and the supply of oxidant gas to the cathode electrode is cut off (S22). At this time, the output potential of the fuel cell is preferably about 0.05 V per cell.

Then, a cyclic voltammogram of the single fuel cell in the stack is measured while supplying inert gas such as nitrogen gas to the cathode electrode (S23). Based on the thus-measured result, the deterioration of the core-shell type catalyst particle is determined to judge whether catalyst activity recovery operation is needed or not (S24).

When it is judged that the catalyst activity recovery operation is needed, the operating point is shifted to an optimal operating point of 0.9 V or more, which is higher than the standard electrode potential of palladium (S25). At this time, the potential is kept until the target time is passed (S26). After the target time is passed, the operating point backs to the point before it is shifted, and then the means for recovering the catalyst activity ends (S27).

A series of routine shown in FIG. 6 can be combined with the stop processing and/or start-up processing of the whole fuel cell system.

When the voltage higher than the standard electrode potential of the core metallic material as mentioned above is applied to the fuel cell, the concentration of gas (fuel gas) which is supplied to the anode electrode and the concentration of gas (oxidant gas) which is supplied to the cathode electrode can be controlled. In particular, the concentration of the gas which is supplied to one of the anode electrode and the cathode electrode is increased higher than that of the same which is generally supplied; or the concentration of the gas which is supplied to the other electrode is decreased lower than that of the same which is generally supplied; or the concentrations of the gasses are controlled at the same time.

Herein, the concentration of each gas can be defined mainly by its gas pressure and gas composition ratio. In the case of a system comprising two or more kinds of gas components, the gas pressure refers to the pressure of the gas mixture, that is, the total pressure. Also, the gas composition ratio can be defined by the partial pressures of the gas components. Furthermore, the gas concentration can be defined even by other physical variable such as temperature.

Herein, the concentration of the gas which is generally supplied refers to the concentration of the gas which is supplied to the fuel cell under a normal operation environment of the fuel cell.

An example of the fuel gas having a generally supplied gas concentration is hydrogen gas having a pressure of 1 atm and a composition ratio of 100%.

Examples of the oxidant gas having a generally supplied gas concentration include air having a total pressure of 1 atm and oxygen gas having a pressure of 1 atm and a composition ratio of 100%.

As the method for increasing the concentration of gas higher than that of the same which is generally supplied, there may be mentioned a method for increasing the gas pressure (total pressure) and a method for increasing the partial pressure of the gas. For example, to increase the concentration of hydrogen gas having a pressure of 1 atm and a composition ratio of 100%, the pressure can be increased from 1 to 1.5 atm. Also for example, to increase the concentration of oxygen gas having a total pressure of 1 atm in air, additional oxygen gas can be added to the air to increase the partial pressure of the oxygen gas, or the total pressure can be increased from 1 to 1.5 atm.

On the other hand, as the method for decreasing the concentration of gas lower than that of the same that is generally supplied, there may be mentioned a method for decreasing the gas pressure (total pressure) or a method for decreasing the partial pressure of the gas. For example, to increase the concentration of hydrogen gas having a pressure of 1 atm and a composition ratio of 100%, the pressure can be decreased from 1 to 0.5 atm, or the hydrogen gas can be mixed with inert gas such as nitrogen to have a composition ratio of 50%. It is also possible to decrease the partial pressure of the hydrogen gas by humidifying the hydrogen gas and mixing the same with water vapor. Also for example, to decrease the concentration of oxygen gas having a total pressure of 1 atm in air, additional inert gas such as nitrogen gas can be added to the air to decrease the partial pressure of the oxygen gas, or the total pressure can be decreased from 1 to 0.5 atm. It is also possible to decrease the partial pressure of the oxygen gas by humidifying the air and increasing the partial pressure of the water vapor in the air.

By controlling the gas concentration, it is possible to control the area on which the core metallic material is once precipitated.

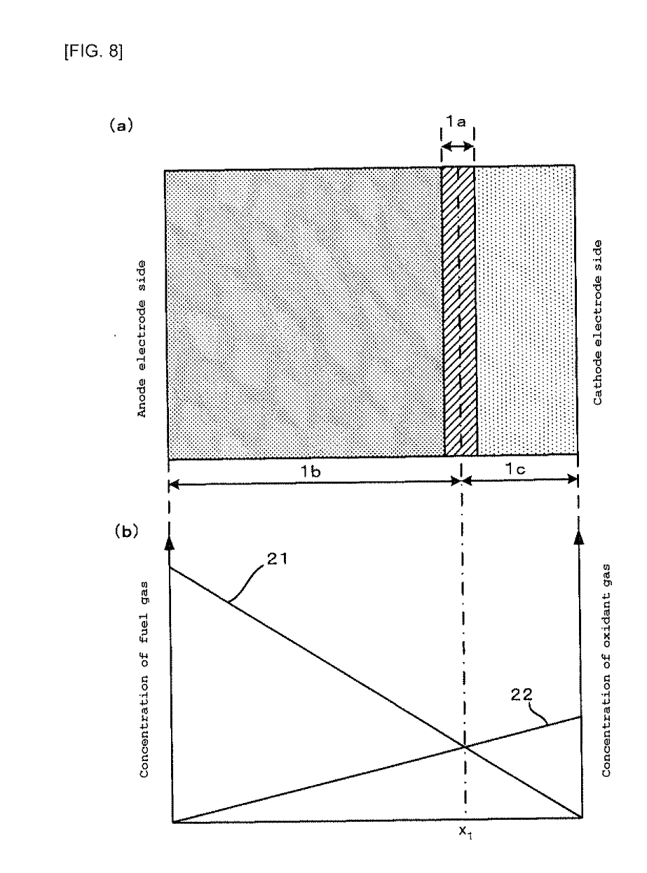

FIG. 8 is a schematical view showing a distribution of the gas concentrations in the electrolyte membrane in the membrane electrode assembly, under normal gas concentration control. FIG. 8(a) is a schematic sectional view of the electrolyte membrane, and FIG. 8(b) is a graph schematically showing a distribution of the gas concentrations in the thickness direction of the electrolyte membrane which corresponds to that of FIG. 8(a). To the membrane electrode assembly, oxygen gas is supplied as oxidant gas, and hydrogen gas is supplied as fuel gas. The core portion of the core-shell type catalyst particle contains palladium, and the core-shell type catalyst particles are contained only in the cathode electrode.

Compared to oxygen gas, hydrogen gas has higher solubility in the electrolyte membrane and a higher diffusion coefficient into the electrolyte membrane. Therefore, as shown in FIG. 8(b), a position x₁ in the electrolyte membrane thickness direction is closer to the cathode electrode side, the position x₁ being a point where a graph 21 of hydrogen gas concentration intersects with a graph 22 of oxygen gas concentration, and also being a point where hydrogen gas and oxygen gas are at the theoretical air fuel ratio (stoichiometry).

The potential inside the electrolyte membrane is high in a region 1c between the position x₁ and the cathode electrode side, and it is close to the cathode electrode potential (around 1.0 V). To the contrary, the potential inside the electrolyte membrane is low in a region 1b between the position x₁ to the anode electrode side, and it is almost the same as the cathode electrode potential (about 0 V) (Journal of Electroanalytical Chemistry 601; 251-259; 2007).

A palladium ion eluted from the cathode electrode is diffused to the anode electrode side through the electrolyte membrane by the concentration gradient. However, the potential in the region 1b is always lower than the standard electrode potential of palladium (0.915 V), so that the palladium ion is reduced to metallic palladium to reprecipitate palladium. The palladium ion is immediately reduced when it reaches the position x₁ by diffusion; therefore, a large amount of palladium is reprecipitated in a region 1a around the position x₁.

In the region 1c, when the potential reaches about 0.9 V or more by controlling the fuel cell operation, palladium is present in the form of palladium ion. When the potential becomes about 0.9 V or less, palladium is reprecipitated as metallic palladium. As just described, in the region 1c, dissolution and precipitation of palladium are repeated due to the change in potential by controlling the fuel cell operation.

Therefore, even though the palladium precipitated on the shell portion is eluted by the operation control as described above, if the fuel cell is continuously operated at its theoretical air fuel ratio in normal operation, palladium could be reprecipitated on the shell of the core-shell type catalyst particle.

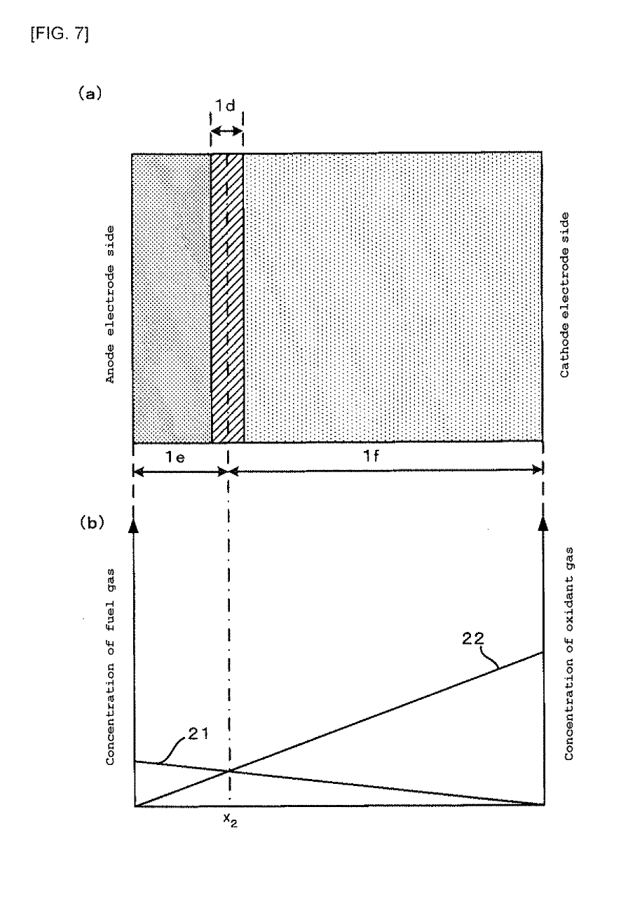

FIG. 7 is a schematical view showing a distribution of the gas concentrations in the electrolyte membrane of the membrane electrode assembly when controlling the gas concentrations. FIG. 7(a) is a schematic sectional view of the electrolyte membrane, and FIG. 7(b) is a graph schematically showing a distribution of the gas concentrations in the thickness direction of the electrolyte membrane which corresponds to that of FIG. 7(a). To the membrane electrode assembly, oxygen gas is supplied as oxidant gas, and hydrogen gas is supplied as fuel gas. The core portion of the core-shell type catalyst particle contains palladium, and the core-shell type catalyst particles are contained only in the cathode electrode.

By performing control to decrease hydrogen gas concentration and increase oxygen gas concentration, as shown in FIG. 7(b), a position x₂ in the electrolyte membrane thickness direction is closer to the anode electrode side, the position x₂ being a point where the graph 21 of hydrogen gas concentration intersects with the graph 22 of oxygen gas concentration and also being a point where the hydrogen gas and oxygen gas are at the theoretical air fuel ratio (stoichiometry).

A region 1e between the position x₂ and the anode electrode side is narrower than the region 1b of FIG. 8, and a region if between the position x₂ and the cathode electrode side becomes wider than the region 1c of FIG. 8.

As the position x₂ moves, the position of a region 1d where a large amount of palladium is reprecipitated, is closer to the anode electrode side. Since the region 1d is included in the region 1b of FIG. 8, if the fuel cell operation is returned to normal control after palladium is reprecipitated in the region 1d by controlling the gas concentrations, there is no possibility that the precipitated palladium is eluted again.

As described above, when the core metallic material is not eluted from the core-shell type catalyst particle, the gas concentrations are controlled as usual. On the other hand, after the core metallic material is eluted from the core-shell type catalyst particle, it is possible to precipitate the thus-eluted core metallic material in a desired electrolyte membrane thickness direction by controlling the gas concentrations and thus moving the position in the electrolyte membrane thickness direction where the fuel gas and oxidant gas are at the theoretical air fuel ratio. Therefore, the once-precipitated core metallic material is prevented from re-elution.

As disclosed on pages 253 to 255 of a reference (Journal of Electroanalytical Chemistry, 601; 251 to 259; (2007)), with the premise that the distance between the anode electrode and the cathode electrode is 1, a thickness x₀ starting from the anode electrode is represented by the following formula (III):

$$\begin{matrix}[ Mathematical formula 1 ] & \\ {x}_{0} = \frac{{H}_{H 2} {D}_{H 2} {c}_{H 2}^{0}}{( {H}_{H 2} {D}_{H 2} {c}_{H 2}^{0} + 2 {H}_{O 2} {D}_{O 2} {c}_{O 2}^{0} )} & F ormula ( III )\end{matrix}$$

wherein H_{H2} is Henry's constant of hydrogen in the membrane; D_{H2} is a diffusion coefficient of hydrogen in the membrane; c⁰_{H2} is hydrogen concentration in the anode; H_{O2} is Henry's constant of oxygen in the membrane; D_{O2} is a diffusion coefficient of oxygen in the membrane; and c⁰_{O2} is oxygen concentration in the cathode.

A specific example of execution of gas concentration control will be described. In the following specific example, air is supplied to the membrane electrode assembly as oxidant gas, and hydrogen is supplied thereto as fuel gas. The core portion of the core-shell type catalyst particle contains palladium, and the core-shell type catalyst particles are contained only in the cathode electrode.

When it is determined that palladium is not eluted from the core-shell type catalyst particle, 100% hydrogen gas having a pressure of 1 atm is supplied to the anode side, and air having a pressure of 1 atm is supplied to the cathode side. That is, 20% oxygen gas having a pressure of 1 atm is supplied to the cathode side. When palladium is eluted from the core-shell type catalyst particle under such a gas control, the precipitation position of palladium under open circuit voltage is estimated to be closer to the cathode electrode side (FIG. 8).

The utilization rate of the supplied gasses in the membrane electrode assembly could be decreased with time. In this case, the precipitation position of palladium is calculated based on the product of the pre-calculated gas concentrations and the utilization rates of the gasses.

When it is determined that palladium was eluted from the core-shell type catalyst particle, the gas concentrations are controlled to supply 5% hydrogen gas having a pressure of 1 atm to the anode side and air having a pressure of 1.5 atm to the cathode side. That is, 20% oxygen gas having a pressure of 1.5 atm is supplied to the cathode side. Under such a gas control, the precipitation position of palladium under open circuit voltage is estimated to be closer to the anode electrode side (FIG. 7).

The gas concentrations can be controlled while recovering the deterioration of the core-shell type catalyst particle. As a result, by increasing the cell potential of the fuel cell to 0.9 V or more and keeping it for a predetermined period of time, the core metallic material precipitated on the surface of the core-shell type catalyst particle is eluted; moreover, by controlling the gas concentration of fuel gas at the anode electrode side to be lower and/or controlling the gas concentration of oxidant gas at the cathode electrode side to be higher, the precipitation position of the core metallic material is close to the anode electrode side. Therefore, the precipitated core metallic material is prevented from re-elution. It is more effective to control both the fuel gas concentration and oxidant gas concentration at the same time, than to control one of the gas concentrations, so that the precipitation position is closer to the anode electrode side.

### 3-3. Determining Means (3)

The determining means (3) is a means that makes a determination based on a detection result obtained by a detecting means. The detection means refers to a means for detecting gas produced in the cathode electrode. The detecting means can be provided to an oxidant gas channel or out of the fuel cell.

In the present invention, the detecting means can be a means for detecting carbon dioxide. Hereinafter, there will be described the case where a core-shell type catalyst particle containing palladium in the core portion and platinum in the shell portion is used, the cathode catalyst layer of the cathode electrode comprises a carbon carrier as a catalyst carrier, and the detecting means detects carbon dioxide produced in the cathode electrode.

According to a reference (ECS Transactions, 25 (1); 1045 to 1054; (2009)), it is known that carbon monoxide (CO) derived from a hydroxyl group (—OH) on carbon (carrier) is produced and after the carbon monoxide moves onto platinum, it is electrochemically oxidized at around 0.4 to 1.0 V and the reaction of the following formula (IV) proceeds, thereby producing the carbon dioxide:

Pt—CO+Pt—OH→CO₂+2Pt+H⁺+e⁻ (IV)

The carbon dioxide is desorbed from platinum at the same time as its production.

This phenomenon can be said to be the same as that occurred in the CO stripping CV explained in the description of the determining means (1) Therefore, as with on palladium, the carbon monoxide derived from the hydroxyl group on the carbon (carrier) is thought to be electrochemically oxidized to produce carbon dioxide. Also, the potential at which the oxidation of the carbon monoxide peaks, that is, the potential at which the production of carbon dioxide peaks, corresponds to the potential at which the desorption of carbon monoxide peaks, which is explained in the description of the determining means (1). Therefore, as described above, the potential at which the production of carbon dioxide peaks is estimated to be about 0.62 V (vs RHE) in the case where the carbon monoxide is oxidized on platinum, and about 0.82 V (vs RHE) in the case where the carbon monoxide is oxidized on palladium.

The inventors have applied such a principle and have found a method for assuming whether or not the ratio of palladium of the core metallic material to the surface of the core-shell type catalyst particle is increased, compared to the initial value.

In particular, by applying the above principle, potential is increasingly applied to the fuel cell at a constant rate. At this time, if a carbon dioxide sensor can detect carbon dioxide production, from the value of the potential at which the production of carbon dioxide peaks, it is possible to estimate whether or not the ratio of palladium of the core metallic material to the surface of the core-shell type catalyst particle is increased compared to the initial value.

The amount of carbon dioxide produced is small, so that the peak of oxidation current of carbon monoxide is significantly low. Therefore, unlike the determining means (1), it is impossible to detect the oxidation current of carbon monoxide, and thus the amount of carbon dioxide is needed to be quantified directly by the carbon dioxide sensor.

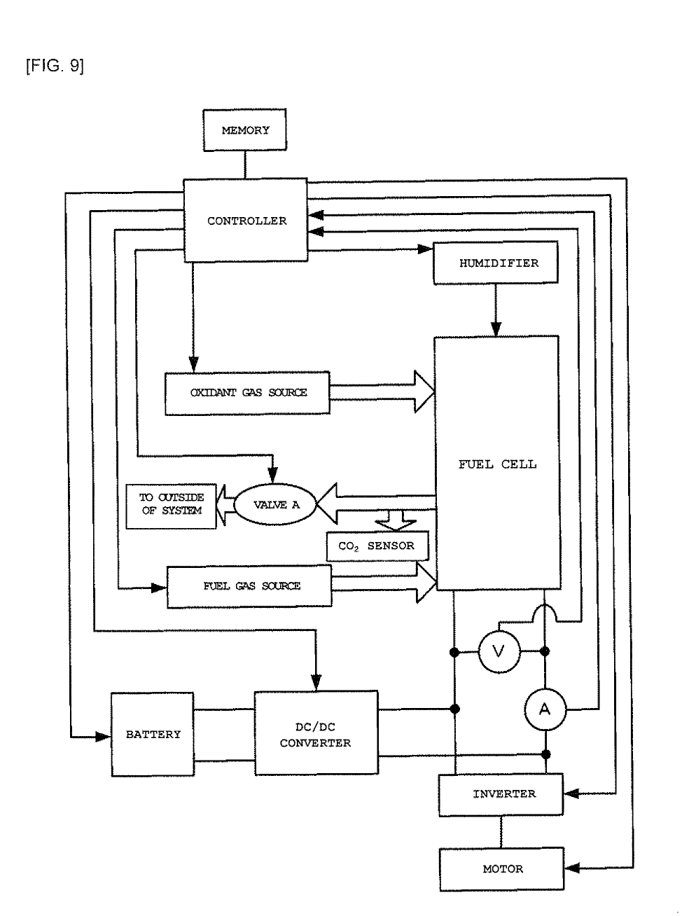

Hereinafter, as a means for detecting carbon dioxide, there will be described a specific constitution of the fuel cell system equipped with a carbon dioxide sensor (hereinafter, referred as to a CO₂ sensor). FIG. 9 is a schematical view of an embodiment of the fuel cell system of the present invention, which is equipped with a CO₂ sensor. The constitution shown in FIG. 9 is the same as the constitution shown in FIG. 2 except that a CO source, CO adsorbent and valve B are not mounted and a CO₂ sensor is mounted.

The valve A functions to isolate the gas discharge channel of the fuel cell from the outside of the fuel cell system. By closing the oxidant gas source and the valve A, the cathode side of the stack can be sealed.

In the middle of the gas discharge channel, a branch to the CO₂ sensor is installed.

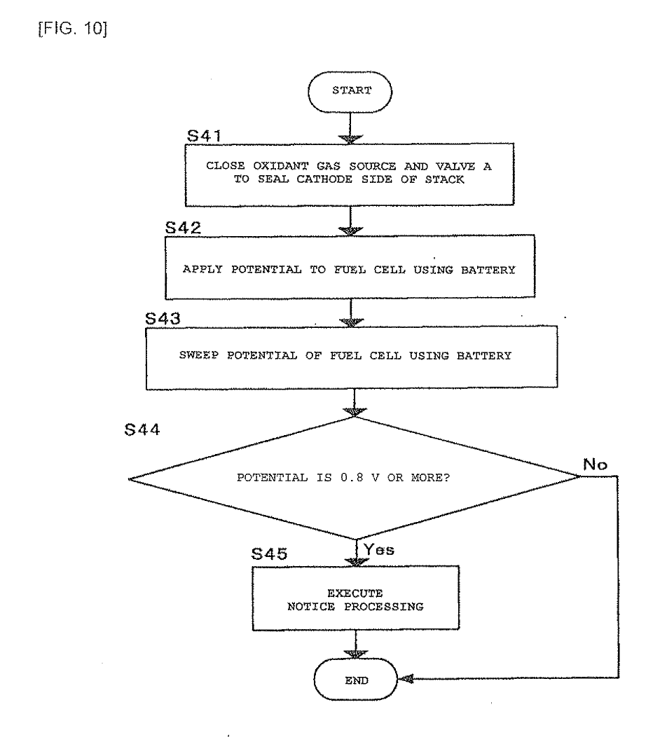

FIG. 10 is a flowchart showing an example of a routine for executing the determining means (3). Machinery names and so on in FIG. 10 correspond to those in FIG. 9. To the fuel cell, air is supplied as oxidant gas, and hydrogen is supplied as fuel gas. Also, the core portion of the core-shell type catalyst particle contains palladium, and the shell portion thereof contains platinum.

First, the oxidant gas source and the valve A are closed to seal the cathode side of the stack (S41). After a sufficient amount of time is passed in the state of sealing the cathode side, hydrogen supplied to the anode side penetrates into the cathode side, so that the whole stack is filled with hydrogen, water and nitrogen, and the temperature inside the stack becomes a room temperature.

Next, potential is applied to the whole fuel cell, using the battery (S42). This is to remove the oxide on the surface of the core-shell type catalyst particle and to pretreat the surface. In this case, the potential is preferably about 0.05 V per cell. As needed, a DC-DC converter can be provided between the battery and the fuel cell for power conversion.

Then, the potential of the fuel cell is swept using the battery (S43). A potential from 0.05 V to 1.0 V (vs RHE) is applied to each cell while increasing the potential at a constant rate.

At this stage, carbon dioxide is measured with the CO₂ sensor to detect a potential E at which the amount of carbon dioxide produced peaks. Then, it is determined whether or not the potential E is 0.8 V or more (S44). If the potential E is 0.8 V or more, notice processing is executed (S45). If potential E is less than 0.8 V, the determining means (3) is terminated and normal system start up processing is executed.

As described above, because the sensor which detects gas produced is preliminarily mounted on the fuel cell system, there is no need to mount a gas cylinder or the like on a vehicle to supply gas to the membrane electrode assembly. Therefore, the vehicle equipped with such a fuel cell system is light in gross weight, so that an improvement in fuel efficiency can be achieved; moreover, an improvement in safety upon crash and repair of the vehicle are also achieved.

### REFERENCE SIGNS LIST

1. Solid polymer electrolyte membrane
1a. Region around position x₁ in solid polymer electrolyte membrane
1b. Region from position x₁ to anode electrode side in solid polymer electrolyte membrane
1c. Region from position x₁ to cathode electrode side in solid polymer electrolyte membrane
1d. Region around position x₂ in solid polymer electrolyte membrane
1e. Region from position x₂ to anode electrode side in solid polymer electrolyte membrane
1f. Region from position x₂ to cathode electrode side in solid polymer electrolyte membrane
2. Cathode catalyst layer
3. Anode catalyst layer
4 and 5. Gas diffusion layer
6. Cathode electrode
7. Anode electrode
8. Membrane electrode assembly
9 and 10. Separator
11 and 12. Gas channel
21. Graph of hydrogen gas concentration
22. Graph of oxygen gas concentration
31. Initial voltammogram of core-shell type catalyst particle after supplying hydrogen gas, containing palladium in core portion and platinum in shell portion
32. Voltammogram of core-shell type catalyst particle when palladium (core material) is estimated to be precipitated on shell portion surface
100. Single fuel cell
x₁ and x₂. Electrolyte membrane thickness direction position in which hydrogen gas and oxygen gas are at a theoretical air fuel ratio (stoichiometry)

1. A fuel cell system comprising a fuel cell which comprises single fuel cells, each of which comprises a membrane electrode assembly in which an anode electrode comprising an anode catalyst layer is provided on one surface of a polymer electrolyte membrane, while a cathode electrode comprising a cathode catalyst layer is provided on the other surface of the polymer electrolyte membrane,
wherein at least one of the anode catalyst layer and the cathode catalyst layer comprises a core-shell type catalyst particle having a core portion comprising a core metallic material and a shell portion covering the core portion and comprising a shell metallic material; and
wherein the fuel cell system has:
a means for storing an initial value of a ratio of the core metallic material to a surface area of the core-shell type catalyst particle, and
a means for determining whether or not the ratio of the core metallic material to the surface area of the core-shell type catalyst particle is increased at a predetermined stage, compared to the initial value.

2. The fuel cell system according to claim 1, wherein the determining means makes a determination based on a detection result that indicates gas desorption from the core-shell type catalyst particle and/or a detection result of the gas desorbed.

3. The fuel cell system according to claim 1, wherein the determining means makes a determination based on the ratio of the core metallic material to the surface area of the core-shell type catalyst particle, which is obtained by comparing a current peak at a potential at which first gas that is supplied to at least the membrane electrode assembly and/or an oxide of the first gas is desorbed from the core metallic material, with a current peak at a potential at which the first gas and/or oxide thereof is desorbed from the shell metallic material.

4. The fuel cell system according to claim 3, wherein the first gas is carbon monoxide.

5. The fuel cell system according to claim 1, wherein the core metallic material is a metallic material which absorbs second gas that is supplied to at least the membrane electrode assembly, and the determining means makes a determination based on the presence of a current peak at a potential at which the second gas is released from the core metallic material.

6. The fuel cell system according to claim 5, wherein the determining means further makes a determination based on an integrated value of the current peak.

7. The fuel cell system according to claim 5, wherein the second gas is hydrogen gas.

8. The fuel cell system according to claim 5, wherein oxidant gas is supplied to the cathode electrode, and an amount of the oxidant gas supplied upon executing the determining means is lower than that of oxidant gas supplied in normal operation.

9. The fuel cell system according to claim 5, wherein a voltage higher than a standard electrode potential of the core metallic material is applied to the fuel cell when it is determined by the determining means that the ratio of the core metallic material to the surface area of the core-shell type catalyst particle is increased compared to the initial value.

10. The fuel cell system according to claim 9, wherein the standard electrode potential of the core metallic material is less than a standard electrode potential of the shell metallic material, and the voltage applied to the fuel cell is within the range from the standard electrode potential of the core metallic material to less than the standard electrode potential of the shell metallic material.

11. The fuel cell system according to claim 9, wherein, when a voltage higher than the standard electrode potential of the core metallic material is applied to the fuel cell, a concentration of gas which is supplied to one of the anode electrode and the cathode electrode is increased higher than that of the same which is generally supplied; or a concentration of gas which is supplied to the other electrode is decreased lower than that of the same which is generally supplied; or the concentrations of the gasses are controlled at the same time.

12. The fuel cell system according to claim 9, wherein the core-shell type catalyst particles are contained only in the cathode catalyst layer, and when a voltage higher than the standard electrode potential of the core metallic material is applied to the fuel cell, a concentration of oxidant gas which is supplied to the cathode electrode is increased higher than that of the same which is generally supplied; or a concentration of fuel gas which is supplied to the anode electrode is decreased lower than that of the same which is generally supplied; or the concentrations of the gasses are controlled at the same time.

13. The fuel cell system according to claim 1, wherein the system has a means for detecting gas produced in the cathode electrode, and the determining means makes a determination based on a detection result obtained by the detecting means.

14. The fuel cell system according to claim 13, wherein the cathode catalyst layer of the cathode electrode comprises a carbon carrier as a catalyst carrier, and the detecting means detects carbon dioxide.
